(19) United States
(12) Patent Application Publication
(10) Pub. No.: US 2006/0285559 A1
(43) Pub. Date: Dec. 21, 2006

(54) METHOD FOR CONTROLLING HOST FROM DEVICE COUPLED THERETO USING UNIVERSAL SERIAL BUS AND SYSTEM THEREOF

(76) Inventor: Chih-Hung Cheng, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/160,261

(22) Filed: Jun. 16, 2005

(51) Int. Cl. H04J 3/12; H04L 12/56; H04L 12/28; G06F 15/16; G06F 13/38; G06F 13/12

(52) U.S. Cl. 370/522; 709/208; 370/389

(57) ABSTRACT

A universal serial bus (USB) system includes a host comprising a pattern detector for detecting a predetermined pattern in a USB packet; and an external device being coupled to the host using a USB. When the pattern detector detects the predetermined pattern, the external device is operative to control the host by issuing a USB response packet comprising an external device command from the external device to the host in response to a USB command packet issued from the host.

### BACKGROUND

The invention relates to universal serial bus (USB) systems, and more particularly, to controlling a host from a device on a USB system.

An emerging trend in today's increasing high-tech society is to extend the capability of electronic devices by providing the popular industry-standard cable bus, the Universal Serial Bus (USB), for data exchange between the electronic device and external storage devices such as flash disks, card readers, digital still cameras, etc.

For example, an electronic device that greatly benefits from the addition of a USB port is the DVD player. FIG. 1 shows a DVD player 100 being coupled to a plurality of external devices 102 utilizing a USB interface 104. In addition to the original functions such as playing a variety of disc formats, the DVD 100 player including the USB interface 104 can also play files stored on external devices 102, transfer data from one device 102 to another device 102, and copy video or audio from an optical disc 106 to an external device 102. For most applications on the market today, it is the DVD player 100 that controls the communication with the external devices 102 according to the formats of the USB Mass Storage Class Specification or the USB Mass Storage Class Bulk-Only Transport Specification. By adding the USB interface 104 for connecting the DVD player 100 with a range of USB mass storage devices 102 such as flash disks and card readers, the functionality of the DVD player 100 is significantly increased.

USB Mass Storage compliant devices have gained significant popularity among users, and new devices each become possible connection targets for USB interface enabled electronics devices. For example, flash disks and card readers are widely used as data storage and exchange devices for both PC-related and consumer electronic products. As mentioned, typically a device manufacturer will implement the behavior of the external devices as specified in the USB Mass Storage Class Specification and the USB Mass Storage Class Bulk-Only Transport Specification. The USB Mass Storage Class Bulk-Only Transport Specification refers to the transport of command, data, and status informing occurring solely on the communication flow of USB Bulk Transfers. A flowchart diagram of the command/data/status protocol of the USB Mass Storage Class Bulk-Only Transport is shown in FIG. 2.

On the USB host side, such as the DVD player 100 shown in FIG. 1, the host controller typically includes a corresponding device class driver that follows the above-mentioned specifications for communicating with the mass storage compliant devices 102 connected via the USB interface 104.

FIG. 3 shows a diagram illustrating a typical USB mass storage bulk-only transport communication between a host such as the DVD player 100 and a card reader 102. In this example application for the DVD player 100 with USB interface 104, an external flash card 103 contains JPG files to be displayed on a television (TV) screen 110 and is accessed by the card reader 102 being connected to the DVD player 100. The DVD player 100 having the USB interface 104 is equipped with hardware and software for becoming a USB host controller that can access a wide range of devices 102 including the card reader 102. The communication between the DVD player 100 and the card reader 102 follows a command sequence similar to that shown in FIG. 3.

Firstly, at time 300, the host sends a standard mass storage command to the device in the command transport. As an example, in the command transport, the DVD player 100 may send the standard SCSI Test Unit Ready command to the card reader 102 having external flash card 103 to query the presence of a specific memory card. No data transport is required for the command as specified in the specification, and, in the status transport, the card reader 102 having the external flash card 103 may report a value such as “Unit Attention” to indicate if the queried memory card 103 is ready for access. Next, for example, the DVD player 100 sends a standard SCSI Request Sense command to get more information from the card reader 102 having the external flash card 103. After receiving the command from the host, at time 302, the device prepares for transmitting or receiving the specific data that the host requested. During the data transport, the card reader 102 is required to report a specific data structure, referred to as “Sense Data”, for the DVD player 100 to determine whether or not an error has occurred in the flash card 103. There is also a following status transport to represent the completion of the command.

Finally, at step 304, the host initiates the status transport and receives the command status reported from the device. If the Sense Data shows no error has occurred in the flash card 103, the DVD player 100 begins to access the memory card 103 by sending a SCSI Read command (or a SCSI Write command) to specify the logical block address and number to acquire a certain length of data on the memory card 103. Once the data is ready for transport, the card reader 102 having the external flash card 103 will begin to send the required data to the DVD player 100 in the data transport. Upon the completion of the SCSI Read command, the DVD player 100 will have the required data in its own memory buffer, and may then begin to decode and display the JPG images on the attached TV screen 110.

### SUMMARY

One objective of the claimed invention is to provide a simple and robust vendor protocol not requiring external hardware that allows a device to control a host within a universal serial bus (USB) system.

According to an exemplary embodiment, a method of controlling a host from an external device coupled thereto using a universal serial bus (USB) is disclosed. The method comprises detecting a predetermined pattern in a packet transmitted from the external device to the host; and when the predetermined pattern is detected, controlling the host from the external device by issuing a USB response packet comprising an external device command from the external device to the host in response to a USB command packet issued from the host.

According to another exemplary embodiment, a universal serial bus (USB) system comprising a host comprising a pattern detector for detecting a predetermined pattern in a USB packet; and an external device being coupled to the host using a USB; wherein when the pattern detector detects the predetermined pattern, the external device is operative to control the host by issuing a USB response packet comprising an external device command from the external device to the host in response to a USB command packet issued from the host.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a DVD player being coupled to a plurality of external devices utilizing a universal serial bus interface according to the related art.

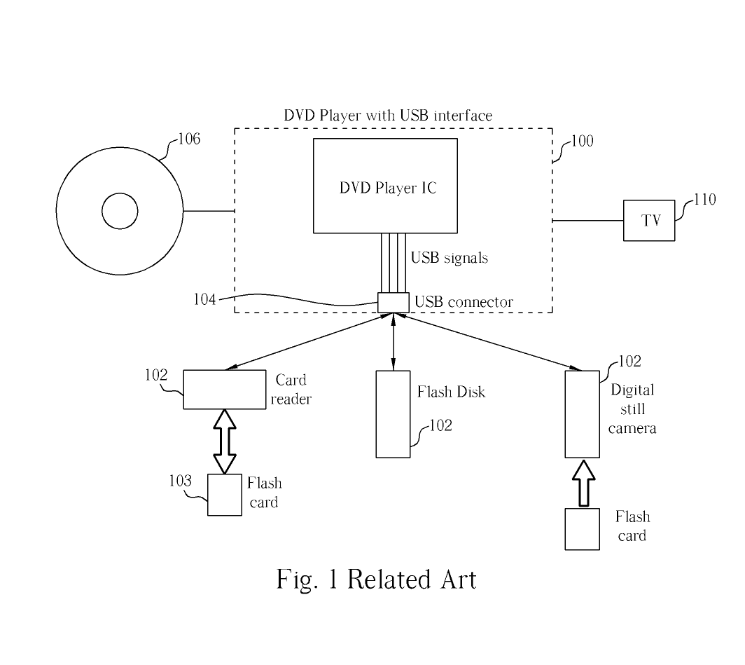

FIG. 2 is a flowchart diagram of the command/data/status protocol of the universal serial bus Mass Storage Class Bulk-Only Transport.

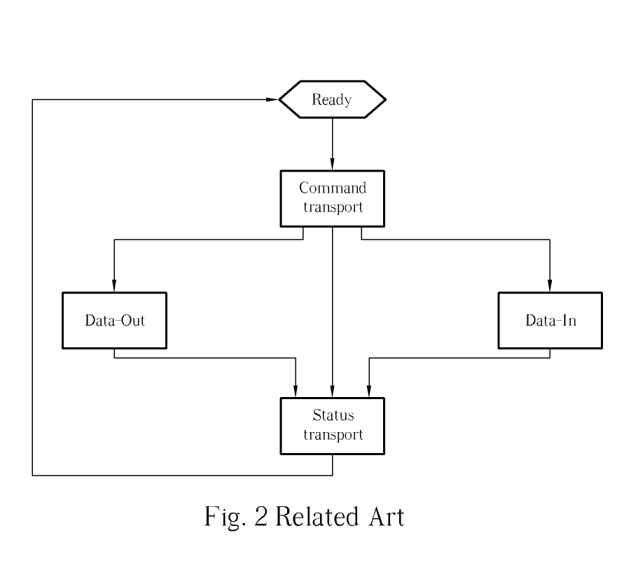

FIG. 3 is a diagram illustrating a typical universal serial bus mass storage bulk-only transport communication between a host, such as the DVD player and a device such as the card reader device of FIG. 1.

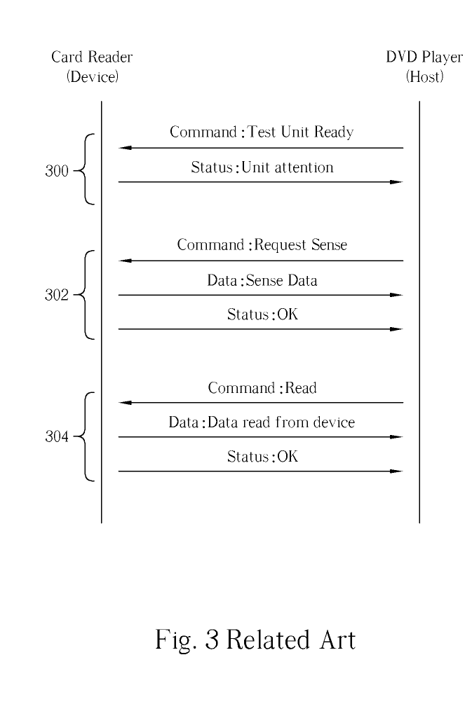

FIG. 4 shows a conceptual view of a universal serial bus system including an external device controlling a host according to an exemplary embodiment.

FIG. 5 shows a flowchart describing the operation of a universal serial bus system according to an exemplary embodiment.

FIG. 6 shows a command sequence between the host and the device of FIG. 4 according to an exemplary embodiment.

FIG. 7 shows an example application according to an exemplary embodiment.

FIG. 8 shows a generalized flowchart describing the steps of controlling a host from an external device coupled thereto using a universal serial bus according to an exemplary embodiment.

### DETAILED DESCRIPTION

The above illustrated USB communication method requires that the host (e.g., the DVD player 100) acts as the controller. However, it would be much more beneficial for an external device 102 to act as a controller of the USB communication. For example, it would be beneficial if a device 102 could control a host 100 to access information stored on a network accessible by the host. There are software based solutions that attempt to achieve the goal of controlling the behavior of a USB system by a device command. Typically, these software based solutions involve developing a complicated vendor protocol and using the protocol on both the USB host and the device. To avoid the errors and related performance problems, a great deal of effort must be exerted to develop a vendor protocol that is equally as stable and robust as the Mass Storage Class Bulk-Only Transport.

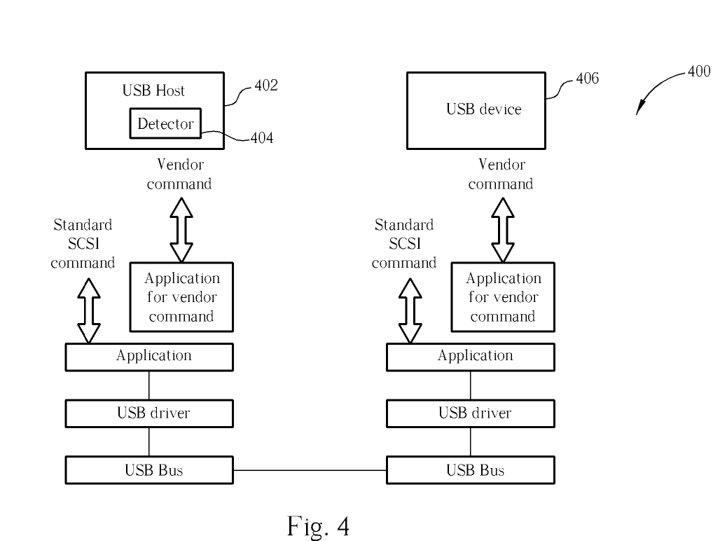

FIG. 4 shows a conceptual view of a universal serial bus (USB) system 400 including an external device 406 controlling a host 402 according to an exemplary embodiment. As previously described, a host controller in a USB system 400 initiates communication with a device and instructs the device to perform various actions. However, according to an exemplary embodiment, the direction of control is reversed and the device 406 instead controls the host 402. As will be explained, this enables the device 406 to control the host 402 and thus manipulate the host 402 and USB system 400 to perform actions desired by the device 406. Moreover, no additional hardware is required according to the exemplary embodiment. That is, the exemplary embodiment largely extends the range of applications by exchanging the leading role of a USB enabled host 402 with a USB enabled device 406 without additional hardware.

In order to ensure robust and reliable communication between the host 402 and the device 406, a set of pre-defined vendor specific commands are embedded in standard SCSI commands sent between the host 402 and the device 406 without changing the original USB command sequence or protocol. The hardware and original USB driver will not be aware of the included vendor commands; however, application software beyond the USB driver may recognize these vendor commands on both the host 402 and device 406 sides as depicted in FIG. 4. In this way, all data transactions between the host 402 and the device 406 comply with the USB class specification while performing communication between the external device 406 and the host 402.

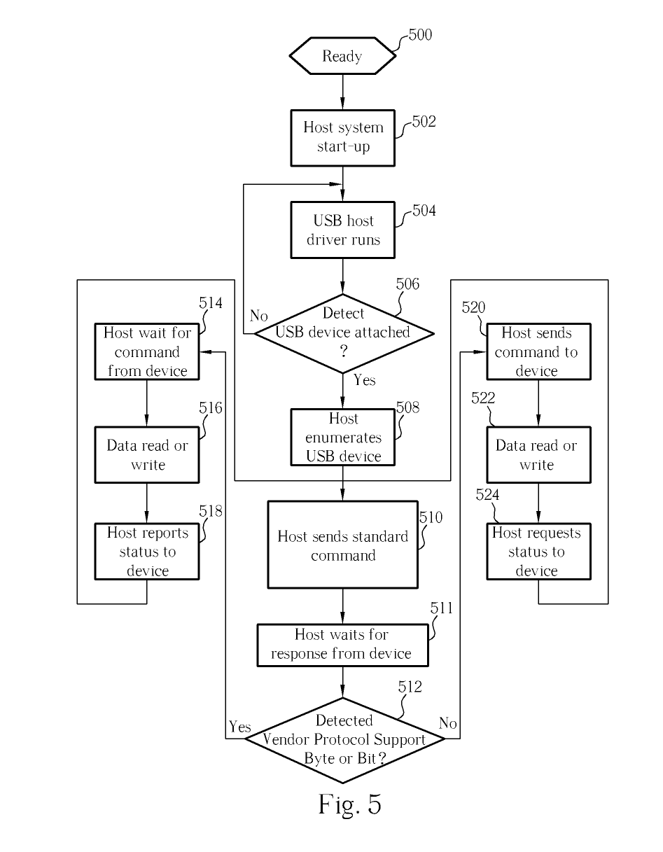

FIG. 5 shows a flowchart describing the operation of a USB system 400 according to the exemplary embodiment. Provided that substantially the same result is achieved, the steps of the flowchart shown in FIG. 5 need not be in the exact order shown and need not be contiguous, that is, other steps can be intermediate. According to this embodiment, the operation of the USB system 400 includes the following steps:

Step 500: Power on the USB system 400 including the device 406 and the host 402.

Step 502: Host 402 system start-up.

Step 504: USB Host 402 driver begins.

Step 506: Does the host 402 detect at least one USB device attached? If yes, control is passed to step 508; otherwise, the host 402 returns to step 504.

Step 508: Host enumerates USB Device to determine which USB enabled devices 406 are attached within the USB system 400.

Step 510: Host 402 sends standard USB command.

Step 511: Host 402 waits for standard USB response, which may also include an embedded vendor protocol command from device. The device receives the standard USB command sent in step 510 and then sends a standard USB response including an embedded vendor protocol command back to the host.

Step 512: Is a Vendor Protocol Support Byte or Bit detected within a returned packet? For example, the host 402 can further include a pattern detector 404 to detect the Vendor Protocol Support Byte or Bit being a predetermined pattern stored in a reserved byte of a returned packet. If yes, control is passed to step 514; otherwise, control is passed to step 520.

Step 514: Host 402 waits for command from device.

Step 516: Data read or write operations are performed by host 402 according to commands received from the device 406. For example, controlling the host 402 from the external device 406 could be performed by embedding the external device 406 command in a reserved byte of the USB response packet being issued by the external device 406 in response to the USB command packet issued from the host 402.

Step 518: Host 402 reports status to device 406.

Step 520: Host 402 sends command to device 406 according to normal USB operations.

Step 522: Data read or write operations are performed by the device 406 according to commands received from the host 402.

Step 524: Host 402 requests status from device 406.

Additional vendor driver software in both the host 402 and the device 406 is utilized to package and un-package the vendor commands within the USB application level. The vendor commands take the place of reserved bytes in the returned data format for the standard commands. According to the desired system application, a variety of other software functions may need to be provided to perform desired functions upon reception of a specific vendor command. At step 520, if the predetermined pattern is not detected, the external device 406 is operative to respond the USB command from the host with a normal USB response packet having no device command included therein.

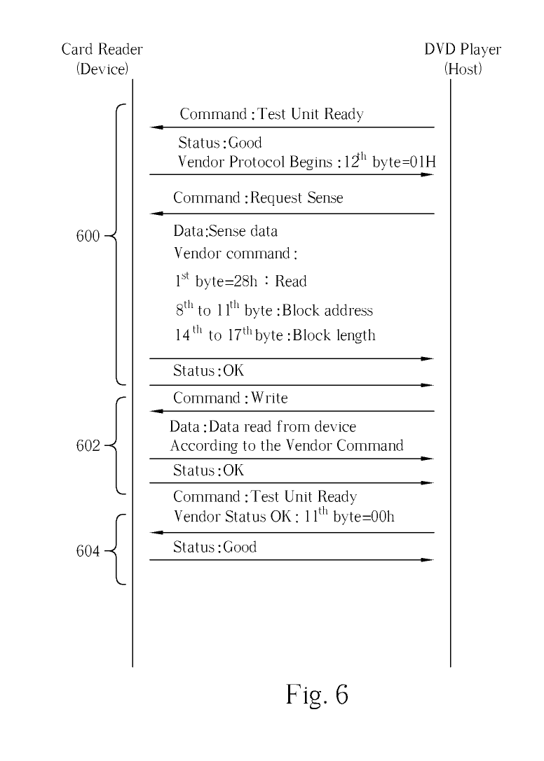

FIG. 6 shows a command sequence between the host 402 and the device 406 according to an exemplary embodiment. At step 600, the host controller 402 sends the standard SCSI Test Unit Ready command to the device 406. Following the USB specification, the device 406 reports its status to the host 402. However, in this embodiment, within the reported status, the value of the 12^{th} byte is set to a value of 1 h. This predetermined pattern is referred to as the Vendor Protocol Support Byte and indicates there is a vendor command embedded within the packet. According to an exemplary embodiment, the device 406 is operative to store the Vendor Protocol Support Byte in a reserved byte of the packet. It should also be noted that the device 406 could also be operative to dynamically assert and de-assert the predetermined pattern, and in another embodiment, the pattern could be implemented as a single bit being a Vendor Protocol Support Bit. For example, the device 406 may only assert the predetermined pattern when it needs to take control of the host 402. At the host controller 402, the application software for the vendor command unpacks the reported status packet and reads the specific byte storing the Vendor Protocol Support Byte, which, in this case, is stored within the 12^{th} byte. In this way, the host will be aware of the incoming embedded vendor protocol and will determine if the reported status packet includes a vendor command from the device 406 in response to a standard command packet sent from host. Upon detecting a valid vendor command (e.g., a value of 28 h indicating a Read command), the vendor command protocol is started. For example, a state machine of the host controller could be implemented as shown in FIG. 5, and at step 512, if the reported status includes the vendor command, the host controller 402 must proceed to step 514 and be prepared to follow vendor commands. In this embodiment, the external device 406 is operative to issue the USB response packet being a status packet in response to the USB command packet issued from the host 402.

Next, while continuing to follow the standard USB protocol, the host 402 sends the SCSI Request Sense command to the device 406 while actually waiting for the vendor command within the Sense Data structure. The 1^{st}, 8^{th} to 11^{th}, and 14^{th} to 17^{th} bytes of the Sense Data structure are used according to the exemplary embodiment for a vendor Read command for a specific logical block address and for a certain number of blocks. For example, in this embodiment, the value of the 1^{st} byte is set to 28 h to indicate a Read command, the values of the 8^{th} byte to the 11^{th} byte are set to a particular block address, and the value of the 14^{th} byte to 17^{th} byte are set to a particular block length. That is, the external device 406 is operative to issue an additional USB response packet comprising the external device 406 command. It should also be noted, multiple commands can be issued by the device 406 to the host, and the exemplary embodiment is not limited to a single command. In general, the device 406 issues additional USB response packets to the host 402 comprising external device commands. Afterwards, at step 602, the host controller 402 behaves according to the device 406 command and prepares the required data in a memory buffer. Finally, the host 402 begins to send the data to the device 406 by sending a write command while actually being guided by the previous vendor Read command from the device 406.

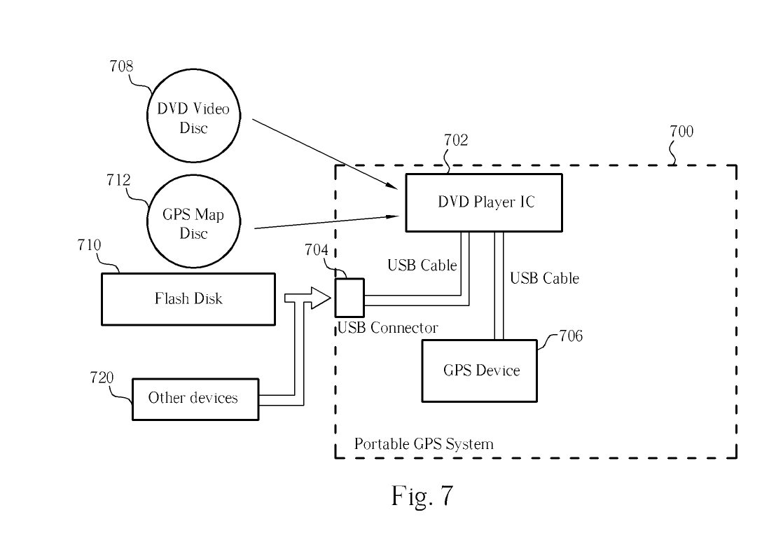

FIG. 7 shows an example application according to an exemplary embodiment. Benefits of the embedded vendor command solution according to an exemplary embodiment will be demonstrated by the following example application, wherein the host 700 is a digital versatile disc (DVD) player, and external devices 710, 720 are coupled to the host 700 utilizing a USB port of the DVD player. As depicted in FIG. 7, in this example, the host 700 is utilized in a new application and includes a DVD player 702 with USB interface 704 and an external GPS device 706. The DVD player 702 becomes a USB host while the GPS device is a USB mass storage compliant device. When a DVD-Video disc 708 is inserted in the DVD player 702, the whole system 700 acts as a typical DVD player, and the DVD player dominates the system 700. That is, the system performs the functions of playing DVD-Video and accessing data in an attached flash disk 710. However, when a GPS map disc 712 is inserted, a pre-defined function will be called for the system to switch its state machine from a DVD player mode to GPS system mode. In this mode, the GPS device 706 will be granted the power to control the system 700 according to the flowchart and commands depicted in FIG. 5 and FIG. 6, for example. The DVD player 702 still behaves as a USB host but is actually responsive to the vendor commands to read the data on the map disc 712 for use by the GPS device 706.

It should also be noted that the exemplary embodiment is not limited to having a single external device being coupled to a host. That is, coupling a plurality of external devices 720 to the host 700 using the USB interface 704 is also supported by the exemplary embodiment. With multiple devices, USB packets sent from the host 700 specify a destination external device in the USB command packet issued. Each of the devices 710, 720 can control the host utilizing the vendor control techniques according to the present invention.

The solution according to the exemplary embodiment takes advantage of the convenience and popularity of the USB standard and advances the capability of a host such as a DVD player with a USB interface to provide additional applications. The solution adds a pre-defined vendor protocol (steps 512, 514, 516, 518 in FIG. 5) to the original state machine of a DVD player and embeds a set of vendor commands within the standard format of SCSI command as specified by the USB Mass Storage Class Bulk-Only Transport. In this way, novel applications such as the DVD/GPS system shown in FIG. 7 can be realized by allowing a device to control the host on a USB system. Moreover, the stability and robustness remains the same as the original USB standard. Therefore, the USB interface and the creative embedded vendor command solution together create a multi-functioned DVD player system that can be utilized for future applications.

However, the exemplary embodiment is not limited to only DVD players having USB interfaces. That is, as will be apparent to a person of ordinary skill in the art, the teachings of the exemplary embodiment can also be used for other electronic devices including a USB interface and can be applied to new areas of applications.

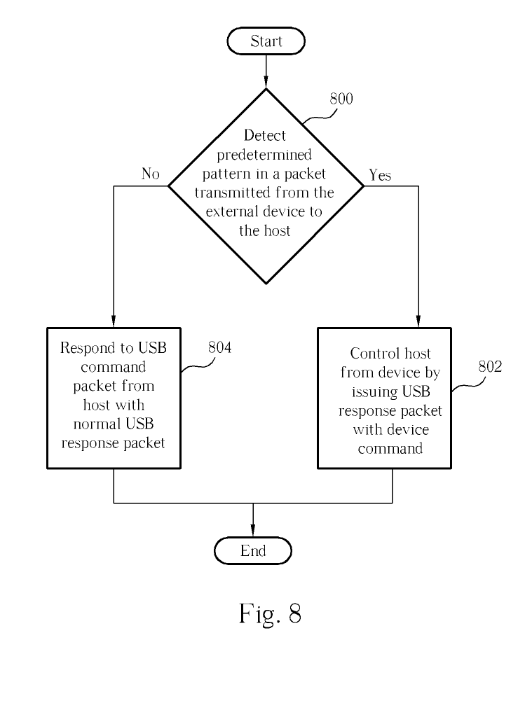

FIG. 8 shows a generalized flowchart describing the steps of controlling a host from an external device coupled thereto using a universal serial bus (USB) according to an exemplary embodiment. Provided that substantially the same result is achieved, the steps of the flowchart of FIG. 8 need not be in the exact order shown and need not be contiguous, that is, other steps can be intermediate. In this embodiment, controlling the host from the external device includes the following steps:

Step 800: Detect a predetermined pattern in a packet transmitted from an external device to a host. For example, provide a pattern detector that is operative to perform to detect the external device every predetermined time interval. In this way, detect if a new external device command is awaiting execution.

Step 802: When the predetermined pattern is detected, control the host from the external device by issuing a USB response packet comprising an external device command from the external device to the host in response to a USB command packet issued from the host.

Step 804: When the predetermined pattern is not detected, perform regular USB operations where the host controls the external device. That is, normal USB operations are conducted between the host and the external device if the predetermined pattern is not detected.

According to the exemplary embodiment, the area of applications for an electronic device with a USB interface (e.g., a DVD player with a USB interface) is significantly enlarged while the additional costs and effort required for implementing the solution are relatively low. In addition, the vendor command protocol according to the exemplary embodiment enjoys the robust nature and stability of the Mass Storage Class Bulk-Only Transport because both host and device still follow the well-defined specification. This thereby saves cost and effort in contrast to developing a complete protocol set and requires only a few vendor commands for a specific new application. Moreover, it is possible to apply the exemplary embodiment to a variety of PC peripherals as well as consumer electronic products because the USB standard is widely accepted on the market. As previously mentioned, it is very convenient to implement the exemplary embodiment by embedding commands from the device within the standard protocol of USB.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of controlling a host from an external device coupled thereto using a universal serial bus (USB), the method comprising:
detecting a predetermined pattern in a packet transmitted from the external device to the host; and
when the predetermined pattern is detected, controlling the host from the external device by issuing a USB response packet comprising an external device command from the external device to the host in response to a USB command packet issued from the host.

2. The method of claim 1, further comprising dynamically asserting and deasserting the predetermined pattern.

3. The method of claim 2, wherein detecting the predetermined pattern is performed every predetermined time interval.

4. The method of claim 1, wherein the predetermined pattern is in a reserved byte of the packet.

5. The method of claim 1, wherein controlling the host from the external device further comprises embedding the external device command in a reserved byte of the USB response packet being issued by the external device in response to the USB command packet issued from the host.

6. The method of claim 1, further comprising complying with a USB class specification while performing communication between the external device and the host.

7. The method of claim 6, further comprising issuing the USB response packet from the external device being a status packet in response to the USB command packet issued from the host.

8. The method of claim 1, further comprising:
coupling a plurality of external devices to the host using the USB; and
specifying a destination external device in the USB command packet issued from the host.

9. The method of claim 1, further comprising issuing from the external device to the host an additional USB response packet comprising the external device command.

10. The method of claim 1, further comprising conducting normal USB operations between the host and the external device if the predetermined pattern is not detected.

11. The method of claim 1, wherein the host is a digital versatile disc (DVD) player, and the external device is coupled to the host utilizing a USB port of the DVD player.

12. A universal serial bus (USB) system comprising:
a host comprising a pattern detector for detecting a predetermined pattern in a USB packet; and
an external device being coupled to the host using a USB;
wherein when the pattern detector detects the predetermined pattern, the external device is operative to control the host by issuing a USB response packet comprising an external device command from the external device to the host in response to a USB command packet issued from the host.

13. The USB system of claim 12, wherein the external device is operative to dynamically assert and de-assert the predetermined pattern.

14. The USB system of claim 13, wherein the pattern detector is operative to detect the external device every predetermined time interval.

15. The USB system of claim 12, wherein the external device is operative to place the predetermined pattern in a reserved byte of the packet.

16. The USB system of claim 12, wherein when the pattern detector detects the predetermined pattern, the external device is operative to embed the external device command in a reserved byte of the USB response packet being issued by the external device in response to the USB command packet issued from the host.

17. The USB system of claim 12, wherein both the host and the external device comply with a USB class specification while performing communication operations on the USB.

18. The USB system of claim 17, wherein the external device is operative to issue the USB response packet being a status packet in response to the USB command packet issued from the host.

19. The USB system of claim 12, further comprising a plurality of external devices being coupled to the host using the USB;
wherein a destination external device is specified in the USB command packet issued from the host.

20. The USB system of claim 12, wherein the external device is further operative to issue an additional USB response packet comprising the external device command.

21. The USB system of claim 12, wherein if the predetermined pattern is not detected, the external device is operative to respond the USB command from the host with a normal USB response packet having no device command included therein.

22. The USB system of claim 12, wherein the host is a digital versatile disc (DVD) player, and the external device is coupled to a USB port of the DVD player.
